(19) United States
(12) Patent Application Publication
(10) Pub. No.: US 2018/0011548 A1
(43) Pub. Date: Jan. 11, 2018

(54) INTERACTING WITH TOUCH DEVICES PROXIMATE TO OTHER INPUT DEVICES

(71) Applicant: Apple Inc., Cupertino, CA (US)

(72) Inventor: Adam T. Garelli, Cupertino, CA (US)

(21) Appl. No.: 15/205,344

(22) Filed: Jul. 8, 2016

(51) Int. Cl. G06F 3/02; G06F 3/044; G06F 3/0354; G06F 3/0488; G06F 3/041

(52) U.S. Cl. CPC G06F 3/0213; G06F 3/04886; G06F 3/0414; G06F 3/03547; G06F 3/044; G06F 2203/04101; G06F 2203/04105

(57) ABSTRACT

In some embodiments, a keyboard is located proximate to a touch sensor that is operable to perform one or more keyboard functions. The state of a touch sensor and/or interaction of an electronic device with the touch sensor is controlled or altered based on detection that an object is proximate to the keyboard. In other embodiments, input to input devices that are proximate are screened. The input devices are located sufficiently proximate that a first input device falsely detects input when a user is actually providing input to a second input device. In particular examples, a location of a user or other object relative to the second input device is determined using a proximity or other sensor. Based on the location, the electronic device determines the user or other object is in position to use the second input device and screens out or filters input from the first input device.

### FIELD

The described embodiments relate generally to input devices. More particularly, the present embodiments relate to interacting with touch devices that are proximate to other input devices, such as touch devices or trackpads that are proximate to keyboards.

### BACKGROUND

Electronic devices, such as computing devices, utilize a variety of different input and/or output components for interacting with users. Examples of input devices or mechanisms may include keyboards, trackpads, computer mice, buttons, switches, microphones, touch screens and/or other touch sensors, and so on. Users may interact with different types of input devices in a variety of different ways in order to direct operations of the associated electronic device and/or otherwise provide input.

For example, laptop computing devices typically include an integrated keyboard and trackpad. The trackpad may be utilized to provide input by directing a cursor shown on a display, selecting graphical icons shown on a display, and so on. Similarly, the keyboard may be used to enter text, commands, and so on. Due to limited available space, the keyboard and trackpad may be located in the same general area of the laptop computing device.

### SUMMARY

The present disclosure relates to input devices that may be located proximate to each other. In some embodiments, a keyboard is located proximate to a touch sensor that is operable to perform one or more keyboard functions. The state of a touch sensor and/or interaction of an electronic device with the touch sensor is controlled or altered based on detection that an object is proximate to the keyboard. In other embodiments, input to input devices that are proximate are screened. The input devices are located sufficiently proximate that a first input device falsely detects input when a user is actually providing input to a second input device. In particular examples, a location of a user or other object relative to the second input device is determined using a proximity or other sensor. Based on the location, the electronic device determines the user or other object is in position to use the second input device and screens out or filters input from the first input device.

In various embodiments, a laptop computing device includes a housing; a keyboard coupled to the housing; a touch sensor component coupled to the housing and configured to operate in a low power state and a high power state; a sensor coupled to the housing; and a processing unit coupled to the sensor. The processing unit transitions the touch sensor component from the low power state to the high power state when the sensor indicates an object is proximate the keyboard. In some examples, the object is proximate the keyboard when the object touches a key of the keyboard.

In numerous examples, the sensor is an optical sensor. The optical sensor may be operable to detect when a key of the keyboard is pressed or when the object touches the key.

In various examples, the processing unit transitions the touch sensor component from the high power state back to the low power state if object is proximate the keyboard beyond a threshold period of time. In some examples, the sensor is positioned between the keyboard and the touch sensor component. In numerous examples, the touch sensor component displays information in the low power state. The touch sensor component is also operable to detect touch in the high power state, but not in the low power state.

In some embodiments, an electronic device includes an enclosure; a keyboard coupled to the enclosure; a force sensing area, coupled to the enclosure, that is operable to perform one or more keyboard functions; a proximity sensor that detects a position of an object relative to the keyboard; and a processing unit coupled to the proximity sensor. The processing unit is operable to alter functionality of the force sensing area based on the position of the object. In various examples, the force sensing area is operable as a virtual numeric keypad.

In numerous examples, the processing unit alters functionality of the force sensing area by waking the force sensing area from a sleep state in response to the proximity sensor detecting that the object is positioned to use the keyboard. In other examples, the processing unit alters functionality of the force sensing area by waking the force sensing area from a sleep state in response to the proximity sensor detecting that the object is moving toward the force sensing area.

In various examples, the processing unit is operable to interpret input received by the force sensing area in a first manner when the proximity sensor detects that the object is in a first position with respect to the keyboard and in a second manner when the proximity sensor detects that the object is in a second position with respect to the keyboard. In some examples the force sensing area is a capacitive touch display. In numerous implementations of such examples, the capacitive touch display provides a first display when the proximity sensor detects that the object is in a first position with respect to the keyboard and a second display when the proximity sensor detects the object is in a second position with respect to the keyboard.

In numerous embodiments, a keyboard includes a housing; keys extending through the housing; a touch sensor coupled to the housing; a proximity sensor at least partially within the housing; and a processing unit coupled to the proximity sensor. The processing unit activates the touch sensor when data from the proximity sensor indicates an object is proximate to one of the keys.

In some examples, the touch sensor is operable to detect a non-binary amount of applied force when activated. In numerous examples, functionality of the touch sensor is dynamically configurable.

In various examples, the touch sensor displays information when activated. In some implementations of such examples, the touch sensor displays first information when the data indicates the object is proximate to a first key of the keys and second information when the data indicates the object is proximate to a second key of the keys. The first information may be associated with a first function of the first key and the second information may be associated with a second function of the second key.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a first example electronic device that screens false input device inputs.

FIG. 1B depicts a user operating the trackpad of the electronic device of FIG. 1A.

FIG. 1C depicts the user operating the keyboard of the electronic device of FIG. 1A.

FIG. 2 depicts an example cross-sectional view of a key of the electronic device of FIG. 1A, taken along line A-A of FIG. 1A.

FIG. 3 depicts an example cross-sectional view of the trackpad of the electronic device of FIG. 1A, taken along line B-B of FIG. 1A.

FIG. 4 depicts a second example electronic device that screens false input device inputs.

FIG. 5 depicts a flow chart illustrating an example method for screening input. This method may be performed by the electronic devices of FIGS. 1A-4.

FIG. 6 depicts a first example electronic device that alters operation of a touch sensor based on proximity of objects to a keyboard.

FIG. 7 depicts a second example electronic device that alters operation of a touch sensor based on proximity of objects to a keyboard.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample apparatuses, systems, methods, and computer program products that embody various elements of the present disclosure. However, it should be understood that the described disclosure may be practiced in a variety of forms in addition to those described herein.

The following disclosure relates to input devices that may be located proximate (e.g., near, adjacent, or the like) to each other. For example, in some embodiments, a keyboard may be located proximate to a touch sensor or other touch sensitive component. The state of a touch sensor and/or interaction of an electronic device with the touch sensor may be controlled or altered when that an object is proximate to the keyboard. The object may be detected to be proximate to the keyboard by one or more proximity sensors or other sensors. The detection may be used to wake the touch sensor out of a low power state, alter how touch sensor input is interpreted, alter options displayed by the touch sensor, and so on.

In other embodiments, accidental input may be screened. In embodiments having first and second input devices or mechanisms near each other, the first input device may falsely detect an input when a user interacts with, or is about to interact with, the second input device. For example, the first input device may falsely detect an input when the user moves across or contacts the first input device when reaching for the second input device. In some implementations of this embodiment, a location of a user or other object relative to the second input device may be determined using a proximity or other sensor. Based on the location, the electronic device may determine whether the user or other object is in position to use the second input device or not. When the user or other object is in position to use the second input device, the electronic device may screen or filter input (e.g., ignore, block, and/or prevent the input from being acted upon) from the first input device. In this way, the issue of “false” inputs from the first input device caused by operation of the second input device may be ameliorated.

The proximity sensor may be a variety of different sensors. Examples of the proximity sensor include optical sensors, capacitive sensors, touch sensors, cameras, and so on. The proximity sensor may be incorporated into the first and/or second input devices, positioned between the first and second input devices, and so on. In some examples, the first and/or second input devices may utilize the proximity sensor to receive input.

The first and second input devices may be a variety of different input devices. For example, the first input device may be a trackpad of a laptop computing device and the second input device may be the keyboard. However, it is understood that this is an example. The first and second input devices may be any kind of input devices, such as one or more touch screens, buttons, trackballs, joysticks, touch panels, touch screens, numeric key pads, and so on.

In various examples, screening input may involve ignoring the detected input. In other examples, screening input may include powering down, disabling, and/or deactivating part or all of the first input device. This may prevent false inputs, as well as conserving power that would otherwise be used by the first input device.

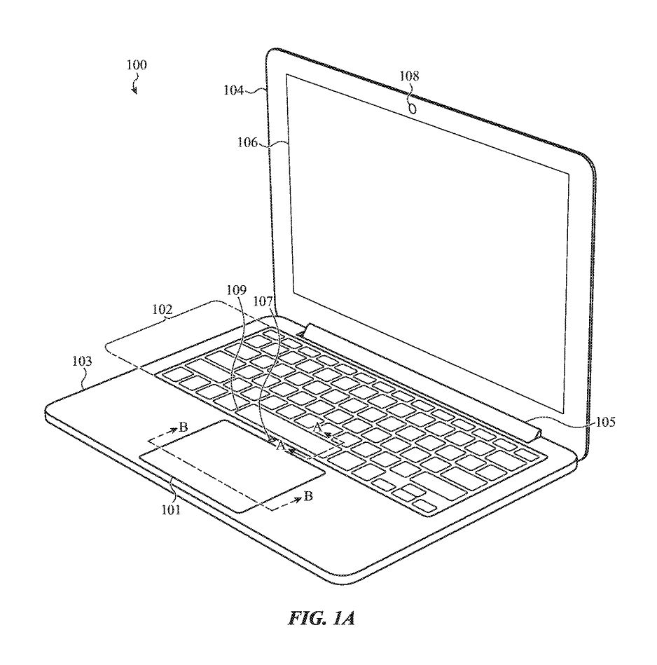

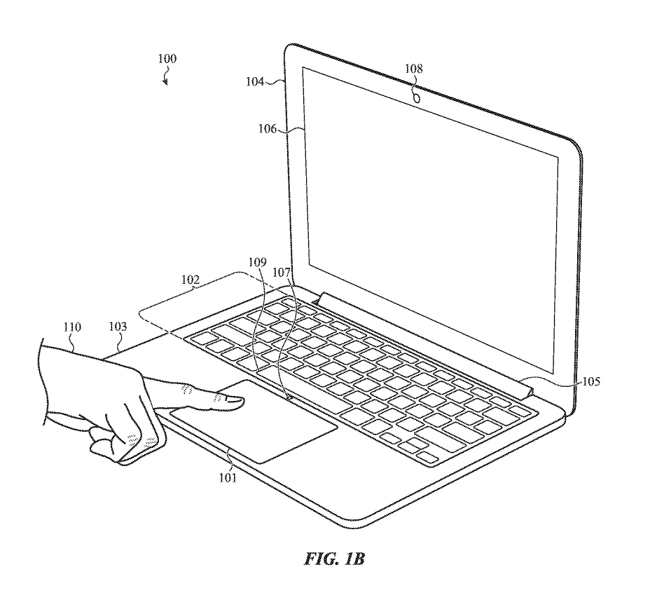

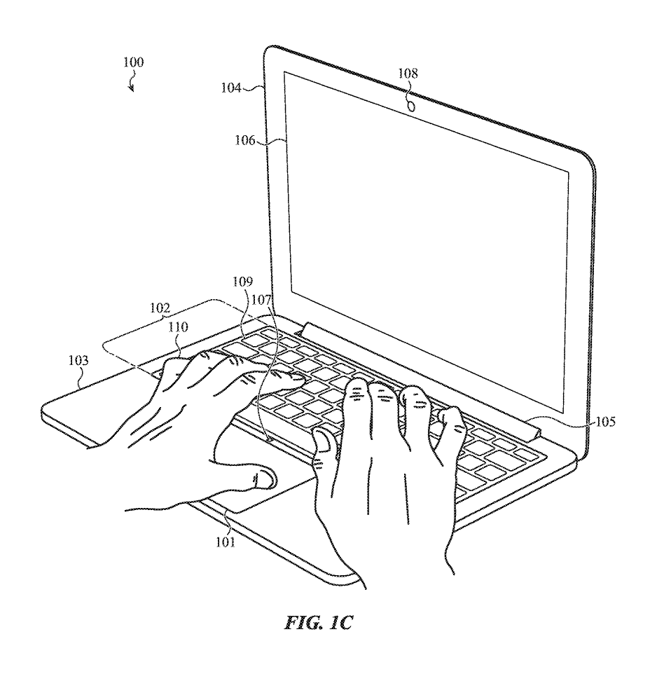

These and other embodiments are discussed below with reference to FIGS. 1-7. However, those skilled in the art will readily appreciate that the detailed description given herein with respect to these Figures is for explanatory purposes only and should not be construed as limiting.

FIG. 1A depicts a first example electronic device 100 that screens false input device inputs. The electronic device 100 includes a trackpad 101 (or other first input device) and a keyboard 102 (or other second input device). The trackpad 101 and keyboard 102 are sufficiently proximate that both may be simultaneously contacted by an object such as a user, stylus, and so on while either is operated. This may result in false inputs being detected by whichever of the trackpad 101 or keyboard 102 is not currently being used or intended to be used. To ameliorate false inputs, the electronic device 100 may screen input from the trackpad 101 a proximity or other sensor 107 detects that the object is in position to use the keyboard 102. FIG. 1B depicts a user 110 operating the trackpad 101 of the electronic device 100 of FIG. 1A. The user's finger is touching the trackpad 101 in order to provide input to the trackpad 101. FIG. 1C depicts the user 110 operating the keyboard 102 of the electronic device 100 of FIG. 1A. As one example of unintentional contact that may be screened, the user's 110 wrist may touch the trackpad 101 while the user 110 provides input to the keyboard 102 via one or more keys 109.

To prevent false trackpad 101 inputs, the electronic device 100 may screen input from the trackpad 101 when the user's 110 hand is in a keyboard 102 position (e.g., the user's 110 hand is in a location relative to the keyboard 102 so as to be positioned to touch one or more keys 109 of the keyboard 102), as shown in FIG. 1C. Similarly, the electronic device 100 may be operable to receive input from the trackpad 101 when data from the sensor 107 indicates that the user 110 is not using, or about to use, the keyboard 102 (as shown in FIG. 1B).

With reference to FIGS. 1A-1C, in some examples, screening trackpad 101 inputs may involve ignoring inputs detected by the trackpad 101. In other examples, the electronic device 100 may screen trackpad 101 inputs by altering an operational state of the trackpad 101. For example, the electronic device 100 may power down the trackpad 101, disable the trackpad 101, deactivate the trackpad 101, and so on. Altering the operational state of the trackpad 101 in this way may both screen false inputs as well as conserve power by preventing the trackpad 101 from using electronic device resources when not in use.

In some implementations, the operational state of the entire trackpad 101 may be altered. However, in other implementations, the operational state of portions of the trackpad 101 may be individually altered in order to selectively screen input. For example, the sensor 107 may indicate that the user 110 may contact part, but not all, of the trackpad 101 while using the keyboard 102. As such, that part of the trackpad 101 may be powered down, disabled, or deactivated, and so on, while the remainder of the trackpad 101 continues to operate. In this way, the user 110 may still be able to provide input to the trackpad 101 while using the keyboard 102 without concern for false trackpad 101 input caused by operating the keyboard 102. Similarly, in various implementations, any part of any input device may be powered down. For example, a keyboard may power down one or more keys, a touch screen may power down a portion of the touch screen, and so on.

In this example implementation, the sensor 107 is coupled to, or operates through an aperture in, a lower housing 103 or enclosure of the electronic device 100. The sensor 107 is positioned between the trackpad 101 and keyboard 102 and at least partially within the lower housing 103. However, it is understood that this is an example. In various implementations, one or more sensors 107 (including optical sensors, capacitive sensors, touch sensors, cameras, and so on) may be variously positioned on, within, or external to the electronic device 100 without departing from the scope of the present disclosure.

For example, the trackpad 101 and/or the keyboard 102 may include one or more components (including switches, buttons, sensors, and/or other components) that may be activated to receive input for the trackpad 101 and/or the keyboard 102. Activation of these components may be analyzed to determine the position of the user 110. Thus, these components may be used as the sensor 107 in various embodiments (or in addition to the sensor(s)). For example, the keyboard 102 may detect a touch and/or press of a key 109, and so may indicate that the user's 110 hand is touching the keyboard 102.

By way of another example, the electronic device 100 may include a camera 108, which may be in an upper housing 104 or enclosure. One or more images obtained by the camera 108 may be analyzed to determine the position of the user 110. As another option, a sensor may be concealed in the display 106 or a hinge 105.

In various implementations, the electronic device 100 may use the sensor 107 for other purposes. For example, the electronic device 100 may be operable in a number of different powered states (such as a sleep, off, or other low power state, an operating or other high power state, and so on). In this example, the electronic device 100 may transition from a low power state (such as a sleep state, an off state, and the like) to a high power state when information from the sensor 107 indicates that the user 110 is positioned to use the trackpad 101, the keyboard 102, or the like.

By way of another example, the electronic device 100 may interpret input received by the keyboard 102 in different manners, based on information from the sensor 107 (which may indicate the position of the user's hands or other body portions. Many keyboards 102 include a key 109 that changes a state of other keys 109. For example, many keyboards 102 include a “shift” key 109 that may be activated to change input from another key 109. Other such keys include “function lock” keys, “number lock” keys, control keys, and so on. In various implementations, information from the sensor 107 regarding the position of the user 110 may be used to replicate activating such a change state key 109. For example, the user 110 may position his hand over the sensor 107 to activate a shift function. In this way, the keyboard 102 may omit one or more typical change state keys 109.

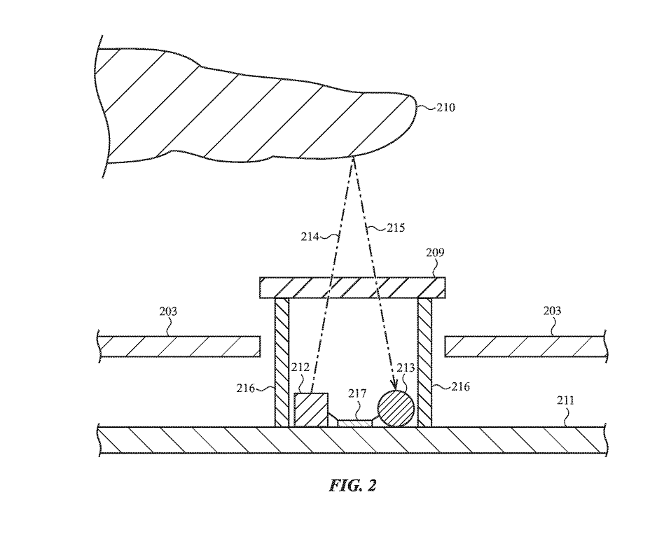

As discussed above, in some implementations, the sensor 107 may be a component of, or integrated into, one or more keys 109 of the keyboard 102. For example, FIG. 2 depicts a key 209 extending through a housing 203 that is moveable with respect to the housing 203. A movement mechanism 216 moveably connects the key 209 to a substrate 211 so the key 209 can move with respect to the housing 203. A controller 217 (or other processing unit) may be coupled to the substrate 211 and may cause an optical or other emitter 212 to emit signals 214. An optical or other receiver 213 may receive the reflected signals 215. The key 209 may be transparent, such that the signals 214 and the reflected signals 215 travel through the key 209. The controller 217 may determine the position of the user's finger 210 and/or if the key 209 is touched or pressed based on the reflected signal 215.

For example, the signal 214 may reflect off of the user's finger 210 and be received by the receiver 213. The controller 217 may analyze whether or not the reflected signal 215 is received, compare times between transmission and receipt, and/or an angle at which the reflected signal 215 is received to determine whether or not the user's finger 210 is positioned above the key 209, touching the key 209, pressing the key 209, and so on. For example, the time between transmission and receipt may be less if the user's finger 210 is touching the key 209 than if positioned above the key 209. Similarly, the time between transmission and receipt may be less if the user's finger 210 is pressing the key 209 (e.g., moving the key toward the substrate 211) than if touching the key. Similarly, if the user's finger 210 is neither on nor above the key 209, the signal 214 may not reflect and the receiver 213 may not receive a reflected signal 215. In this way, the key 209 may include components that are both operable to receive input and determine the position and/or location of the user's finger 210.

Although the key 209 is shown as transparent, it is understood that this is an example. In various implementations, the key 209 may not be transparent. In such an example, the signal 214 may be reflected off of the key 209.

Further, the movement mechanism 216 is illustrated as a representative structure. It is understood that any movement structure may be used. Living hinge structures, scissor mechanisms, spring mechanisms, and the lie are all examples of suitable movement mechanisms that may be incorporated into embodiments.

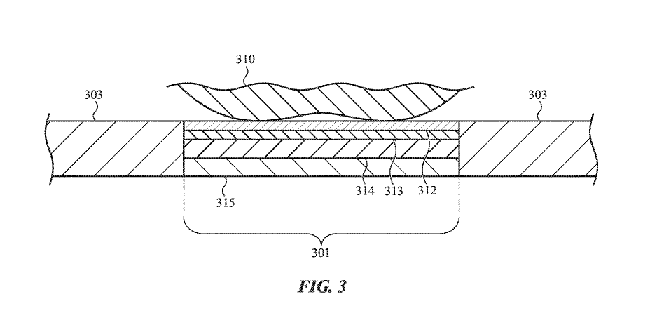

As discussed above, in some implementations, the sensor 107 may be a component of the trackpad 101. For example, FIG. 3 depicts an example capacitive trackpad 301 positioned in a housing 303. The capacitive trackpad 301 may include a number of layers. In this example, the trackpad may include a cover layer 312, a sensing layer, a stiffener layer 315, and potentially other layers and/or structures. The sensing layer may include a conductive layer 313 on a substrate layer 314. However, it is understood that this is an example. In other examples, various conductive materials may be positioned on one or more surfaces of the substrate layer 314 without departing from the scope of the present disclosure.

Capacitance between the user's finger and the sensing layer may be measured. This capacitance may be analyzed to determine how close the user's finger is to the capacitive trackpad 301, whether or not the user's finger is touching the trackpad 301 surface, the force with which the user is pressing the trackpad 301, and so on. This capacitance may be interpreted as input provided to the trackpad 301 by the user.

Further, capacitances between one or more portions of the user's finger and one or more portions of the sensing layer may be different based on how much of the user's finger is proximate to and/or touching the trackpad 301 at various locations. For example, the capacitance when the user's palm 310 (shown) is touching the trackpad 301 may be different than when the user's finger is touching the trackpad 301. The user's finger may touch the trackpad 301 when operating the trackpad 301, but may accidentally touch the trackpad 301 with the user's palm 310 or wrist when operating the adjacent keyboard. Thus, the capacitance may be used to determine whether the user's finger is in a position corresponding to use of the trackpad 301, as opposed to inadvertent touch or hover. In this way, the trackpad 301 may include components that are both operable to receive input and determine the position and/or location of the user's finger.

Although embodiments have been illustrated and described as screening trackpad 101 input when the user 110 or other object is positioned to use the keyboard 102, it is understood that this is an example. In various implementations, input from any first input device or mechanism may be screened when the electronic device 100 determines that the user 110 or other object is positioned to use a second input device or mechanism. For example, in some implementations, the electronic device 100 may screen input for the keyboard 102 upon determining that the user 110 or other object is positioned to use the trackpad 101. By way of another example, in some implementations, the electronic device 100 may both screen input for the keyboard 102 upon determining that the user 110 or other object is positioned to use the trackpad 101 and screen input for the trackpad 101 upon determining that the user 110 or other object is positioned to use the keyboard 102. Various configurations are possible and contemplated.

In various implementations, the electronic device 100 may screen input from one or more input devices that are separate from the electronic device 100, but positioned sufficiently proximate to cause false inputs.

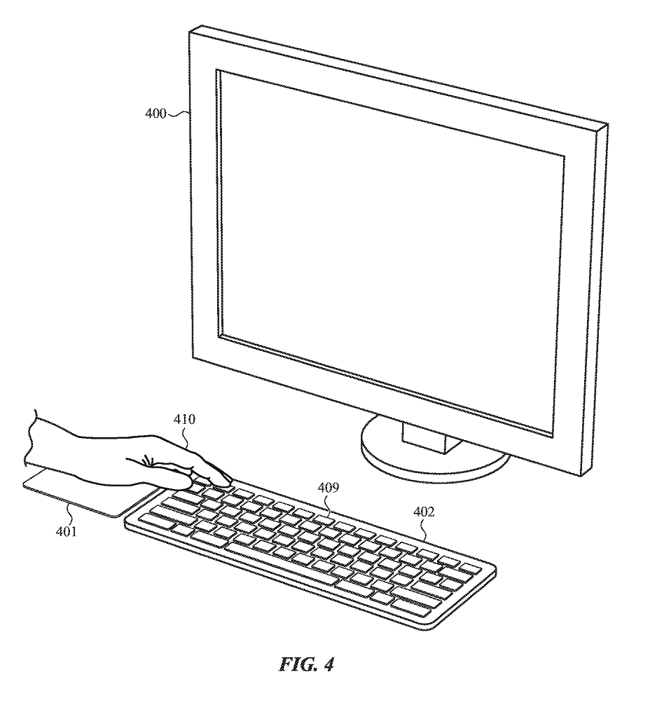

For example, FIG. 4 depicts a second example electronic device 400 that screens false input device inputs. In this example, the electronic device 400 is wirelessly connected to an external trackpad 401 and an external keyboard 402 that includes a number of keys 409. The external trackpad 401 and the external keyboard 402 may be positioned proximate enough to each other that a user's hand 410 may touch (or nearly touch, hover over, and so on) the external trackpad 401 while operating the external keyboard 402. One or more sensors located in the electronic device 400, the external trackpad 401, the external keyboard 402, and so on may provide data to the electronic device 400 regarding the position of the user's hand 410, the position of the external trackpad 401 relative to the external keyboard 402, and so on. Based on the data, the electronic device 400 may screen inputs to the external trackpad 401, the external keyboard 402, and so on.

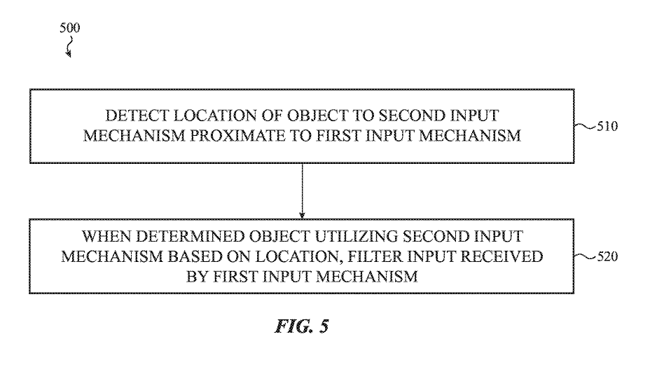

FIG. 5 depicts a flow chart illustrating an example method 500 for screening false input device inputs. This example method 500 may be performed by the electronic devices 100, 400 of FIGS. 1A-4.

At 510, detect a location of an object with respect to a second input mechanism that is proximate to a first input mechanism. The object may be a body part of a user, a stylus, and so on. The first input mechanism may be a trackpad, a touchpad, a touch sensor, a touch sensitive component, a touch screen, and so on. The second input mechanism may be a keyboard, a keypad, a virtual keyboard, a touch screen, and so on.

At 520, filter input received by the first input mechanism when the object is determined based on the location to be utilizing the second input mechanism. The filtering may involve ignoring the input, powering down at least part of the first input mechanism, deactivating at least part of the first input mechanism, disabling at least part of the first input mechanism, and so on.

Although the example method 500 is illustrated and described as including particular operations performed in a particular order, it is understood that this is an example. In various implementations, various orders of the same, similar, and/or different operations may be performed without departing from the scope of the present disclosure.

For example, the example method 500 is illustrated and described as an electronic device filtering input received by the first input mechanism when the electronic device determines the object is interacting with, or about to be interacting with (e.g., near) the second input mechanism. However, in some implementations, the example method 500 may include an additional operation where the electronic device determines whether or not the first input mechanism receives input. In those implementations, the electronic device may omit filtering input received by the first input mechanism if the electronic device determines that the first input mechanism does not receive input.

In other embodiments, the state of a touch sensor (or touch sensor component, touch sensitive component, force sensing area, touch sensing area, touch device, and so on) and/or interaction of an electronic device with the touch sensor may be controlled or altered based on detection that an object is proximate to a keyboard. The detection may be used to wake the touch sensor out of a low power state (such as a sleep state, and off state, a non-powered state, and the like), alter how touch sensor input is interpreted, alter options displayed by the touch sensor, and so on.

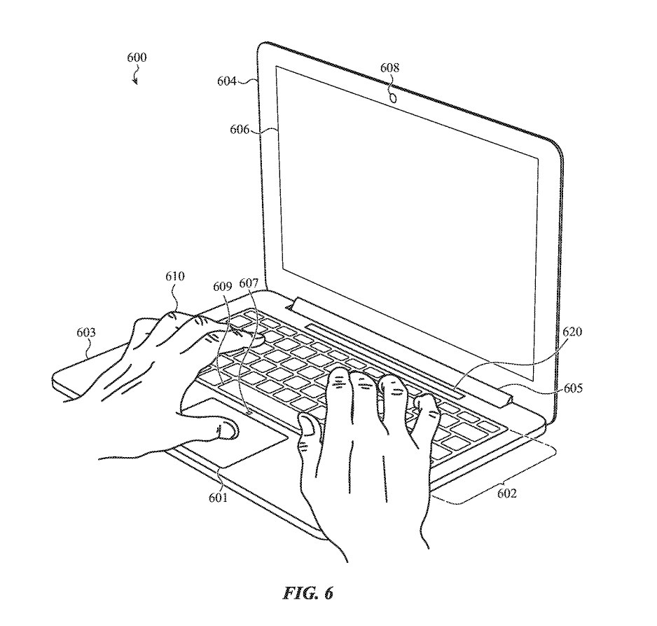

FIG. 6 depicts a first example electronic device 600 that alters operation of a touch sensor 620, force sensor, force sensing area or other force or touch sensitive component based on proximity of one or more objects to a keyboard 602. The touch sensor 620 is operable in numerous power states, such as a low power state and a high power state, an inactive state and an active state, and so on. When a processing unit (or other controller component) of the electronic device 600 detects that an object (such as the user 610) is positioned to use the keyboard 602, the processing unit alters the functionality of the touch sensor 620 based on the detected position.

For example, the touch sensor 620 may be a touch sensing and/or force sensing component, such as a touch screen, strip, or other component (“touch screen”). The touch screen may receive inputs based on the location of a touch, and/or non-binary force amount of a touch, on its surface. The inputs may initiate various functions performable by the electronic device 600. The functions may also be associated with the keyboard 602 (“keyboard functions”). In some implementations, the touch screen may display graphical and/or other information related to the functionalities.

However, the touch screen may utilize a large amount of power. The electronic device 600 may put the touch screen into various different power modes to vary power use. For example, the electronic device 600 may place the touch screen in a power off or inactive state when not in use, and in a power on or active state when in use. The touch screen may not display information or receive inputs in the power off state, but may both display information and receive inputs in the power on state. By way of another example, the touch screen may display information when in a low power state without receiving inputs and may both display information and receive inputs in a high power state.

Regardless of the different power states of the touch screen and the functions performed in such states, the electronic device 600 may utilize detected proximity of an object (such as the user 610) to the keyboard 602 to determine when to wake and/or otherwise transition the touch screen from lower to high power states. As the functions initiated by the touch screen may be perform one or more keyboard 602 functions, proximity of the user 610 to the keyboard 602 may indicate that the user 610 will soon utilize the touch screen. Thus, the electronic device 600 may transition the touch screen to various low power states when the touch screen and/or the keyboard 602 have not been used for a period of time (such as thirty seconds) and may transition the touch screen to various high power states when proximity of the user 610 to the keyboard 602 is detected.

In some implementations, the user 610 may be detected to be in a position to use the keyboard 602 (e.g., proximate the keyboard) when the user 610 is touching one or more of the keys 609 of the keyboard 602. In other implementations, the user 610 may be detected to be in position to use the keyboard 602 when the user 610 is above one or more of the keys 609 of the keyboard 602. In still other implementations, the user 610 may be detected to be in keyboard position when the electronic device 600 detects that the user is moving across or above one or more of the keys 609 of the keyboard 602 and in the direction of the touch sensor 620.

However, the user 610 may use the keyboard 602 without using the touch sensor 620. As such, the electronic device 600 may transition the touch sensor 620 from a low to a high power or waking state upon detecting proximity of the user 610 to the keyboard 602 and then transition the touch sensor 620 back to the low power state if the user 610 remains proximate to the keyboard 602 without using the touch sensor 620 for a threshold period of time (such as forty seconds). The electronic device 600 may also transition the touch sensor 620 from the high power state back to a low power state if the user 610 is no longer proximate to the keyboard 602.

The touch sensor 620 may provide a variety of different functionalities. For example, the touch sensor 620 may be operable to detect different touch locations that correspond to the traditional function keys of a keyboard 602. Further, in some implementations, the functionalities of the touch sensor 620 may be dynamically controllable. The electronic device 600 may interpret input from the touch sensor 620 to correspond to various system-defined functions, user-defined functions, and so on and the electronic device 600 may interpret input from the touch sensor 620 in different manners at different times and/or upon the occurrence of different events.

For example, the electronic device 600 may interpret input from the touch sensor 620 in a first manner when the user 610 is proximate to a first key 609 (such as a “command” key 609) or area of the keyboard 602, and in a second manner when the user 610 is not proximate to the first key 609 or area of the keyboard 602. Thus, the proximity of the user 610 to the keyboard 602 may be used to change the functionality of the touch sensor 620. In some implementations, the first key 609 and/or the manners of interpreting the input from the touch sensor 620 may be user-defined.

In various implementations, the touch sensor 620 may display different information or data when the touch sensor 620 is associated with different functionalities. For example, the touch sensor 620 may display first information or data when the touch sensor 620 input is being interpreted in the first manner and second information or data when the touch sensor 620 input is being interpreted in the second manner.

In implementations where the touch sensor 620 input is interpreted in a first manner when the user 610 is proximate to a first key 609 and in a second manner when the user 610 is proximate to the second key 609, the information or data displayed by the touch sensor 620 may be associated with the functions of the first and second keys 609. For example, the first key 609 may be a “C” key 609 and the second key 609 may be a “X” key 609. The C key 609 may be associated with a “copy” function and the X key 609 may be associated with a “cut” function. As such, the touch sensor 620 may display information or data related to the copy function when the user 610 is proximate to the C key 609 to indicate operations related to the copy function that can be instructed using the touch sensor 620. Similarly, the touch sensor 620 may display information or data related to the cut function when the user 610 is proximate to the X key 609 to indicate operations related to the cut function that can be instructed using the touch sensor 620.

The electronic device 600 may detect proximity similar to one or more of the manners and/or using one or more of the sensors similar to those discussed above. For example, the electronic device may detect proximity and/or location of the user 610 using a proximity or other sensor 607 disposed below the keyboard 602 or in other locations, sensors included in one or more keys 609, a camera 608, and so on.

As illustrated, the electronic device 600 includes a lower housing 603 that is connected to an upper housing 604 by a hinge 605. The camera 608 and a display 606 may be coupled to the upper housing 604. The keyboard 602, the touch sensor 620, sensor 607, and a trackpad 601 may be coupled to the lower housing 603. However, it is understood that this is an example. In various implementations, the electronic device 600 may be any device including a keyboard 602 and a touch sensor 620.

Although the above describes altering operation of the touch sensor 620 based on proximity of one or more objects to the keyboard 602, it is understood that this is an example. In various implementations, the alteration may be based on the proximity of objects to other components, properties other than proximity, and so on.

Although the touch sensor 620 is illustrated and described above as a dynamic function area positioned between the keyboard 602 and the hinge 605, it is understood that this is an example. Various configurations and/or functions of the touch sensor 620 are possible and contemplated without departing from the scope of the present disclosure.

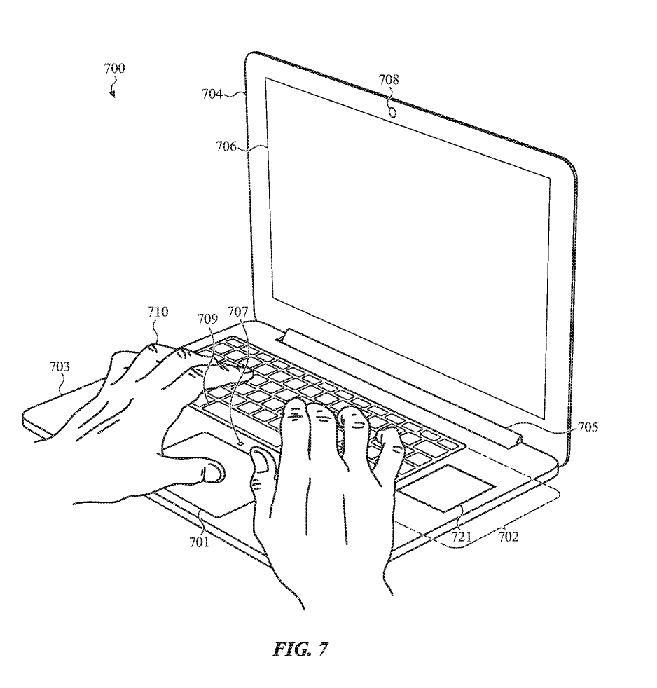

For example, FIG. 7 depicts a second example electronic device 700 that alters operation of a touch sensing component 721 (or other touch sensor, force sensor, for sensing area, or other input device) based on proximity of objects to a keyboard 702. By way of contrast with the electronic device 600 of FIG. 6, the electronic device 700 includes a touch sensing component 721 or area positioned to the side of the keyboard 702.

The touch sensing component 721 may be operable as a virtual numeric keypad. That is, the touch sensing component 721 may be operable to display information and/or receive input relating to the functionality of a numeric keypad. In some implementations, the functionality and/or information displayed by the touch sensing component 721 may be dynamically configurable.

Similar to the electronic device 600 of FIG. 6, the electronic device 700 may transition the touch sensing component 721 between one or more low power states and one or more high power states based on detecting proximity of a user 710 or other object to one or more portions of the keyboard 702.

In examples herein, the electronic device 100 is illustrated as a laptop computing device having a trackpad 101, a keyboard 102, a sensor 107, a lower housing 103, and a camera 108 and a display 106 coupled to an upper housing and connecting hinge 105. However, it is understood that this is an example. In various implementations, the electronic device 100 may include additional components or may omit some listed components. Examples of additional components include one or more processing units (which may be operable to determine the position of the user 110 based signals on from the sensor 107, screen and/or receive input from the trackpad 101 and/or the keyboard 102, and so on), one or more communication components, and one or more non-transitory storage media (which may take the form of, but is not limited to, a magnetic storage medium; optical storage medium; magneto-optical storage medium; read only memory; random access memory; erasable programmable memory; flash memory; and the like), and so on.

Further, in various implementations, the electronic device 100 may be a device other than a laptop computing device. Example electronic devices include a wearable device, a desktop computing device, a digital media player, a display, a printer, a tablet computing device, a fitness monitor, a mobile computing device, a smart phone, a cellular telephone, and so on.

As described above and illustrated in the accompanying figures, the present disclosure relates to interaction with input devices that may be located proximate to each other. In some embodiments, a keyboard may be located proximate to a touch sensor that is operable to perform one or more keyboard functions. The state of a touch sensor and/or interaction of an electronic device with the touch sensor may be controlled or altered based on detection that an object is proximate to the keyboard. In other embodiments, input to input devices that are proximate may be screened. The input devices may be located sufficiently proximate that a first input device falsely detects input when a user is actually providing input to a second input device. In particular examples of these embodiments, a location of a user or other object relative to the second input device may be determined using a proximity or other sensor. Based on the location, the electronic device may determine the user or other object is in position to use the second input device and screen or filter input from the first input device.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A laptop computing device, comprising:
a housing;
a keyboard coupled to the housing;
a touch sensitive component coupled to the housing and configured to operate in a low power state and a high power state;
a sensor coupled to the housing; and
a processing unit, coupled to the sensor, that transitions the touch sensitive component from the low power state to the high power state when the sensor indicates an object is proximate the keyboard.

2. The laptop computing device of claim 1, wherein the object is proximate the keyboard when the object touches a key of the keyboard.

3. The laptop computing device of claim 1, wherein the sensor is an optical sensor.

4. The laptop computing device of claim 3, wherein the optical sensor is operable to detect when a key of the keyboard is pressed or when the object touches the key.

5. The laptop computing device of claim 1, wherein the processing unit transitions the touch sensitive component from the high power state back to the low power state if the object is proximate the keyboard beyond a threshold period of time.

6. The laptop computing device of claim 1, wherein the sensor is positioned between the keyboard and the touch sensitive component.

7. The laptop computing device of claim 1, wherein the touch sensitive component:
displays information in the low power state; and
is operable to detect touch in the high power state, but not in the low power state.

8. An electronic device, comprising:
an enclosure;
a keyboard coupled to the enclosure;
a force sensing area, coupled to the enclosure, that is operable to perform one or more keyboard functions;
a proximity sensor that detects a position of an object relative to the keyboard; and
a processing unit, coupled to the proximity sensor, that is operable to alter functionality of the force sensing area based on the position of the object.

9. The electronic device of claim 8, wherein the force sensing area is operable as a virtual numeric keypad.

10. The electronic device of claim 8, wherein the processing unit alters functionality of the force sensing area by waking the force sensing area from a sleep state in response to the proximity sensor detecting that the object is positioned to use the keyboard.

11. The electronic device of claim 8, wherein the processing unit alters functionality of the force sensing area by waking the force sensing area from a sleep state in response to the proximity sensor detecting that the object is moving toward the force sensing area.

12. The electronic device of claim 8, wherein the processing unit is operable to interpret input received by the force sensing area:
in a first manner when the proximity sensor detects the object is in a first position with respect to the keyboard; and
in a second manner when the proximity sensor detects that the object is in a second position with respect to the keyboard.

13. The electronic device of claim 8, wherein the force sensing area comprises a capacitive touch display.

14. The electronic device of claim 13, wherein the capacitive touch display provides:
a first display when the proximity sensor detects that the object is in a first position with respect to the keyboard; and
a second display when the proximity sensor detects that the object is in a second position with respect to the keyboard.

15. A keyboard, comprising:
a housing;
keys extending through the housing;
a touch sensor coupled to the housing;
a proximity sensor at least partially within the housing; and
a processing unit, coupled to the proximity sensor, that activates the touch sensor when data from the proximity sensor indicates an object is proximate to one of the keys.

16. The keyboard of claim 15, wherein the touch sensor is operable to detect a non-binary amount of applied force when activated.

17. The keyboard of claim 15, wherein the touch sensor displays information when activated.

18. The keyboard of claim 17, wherein the touch sensor displays:
first information when the data indicates the object is proximate to a first key of the keys; and
second information when the data indicates the object is proximate to a second key of the keys.

19. The keyboard of claim 18, wherein:
the first information is associated with a first function of the first key; and
the second information is associated with a second function of the second key.

20. The keyboard of claim 15, wherein functionality of the touch sensor is dynamically configurable.
